(19) United States
(12) Patent Application Publication
(10) Pub. No.: US 2015/0198374 A1
(43) Pub. Date: Jul. 16, 2015

(54) HEAT EXCHANGER

(71) Applicant: MAHLE Behr GmbH & Co. KG, Stuttgart (DE)

(72) Inventor: Ruediger KOELBLIN, Esslingen (DE)

(21) Appl. No.: 14/598,580

(22) Filed: Jan. 16, 2015

(30) Foreign Application Priority Data
Jan. 16, 2014 (DE) 10 2014 200 680.5

(51) Int. Cl. F28D 7/16; B23P 15/26; F28D 9/00

(52) U.S. Cl. CPC F28D 7/1684; F28D 9/0043; B23P 15/26

(57) ABSTRACT

A heat exchanger, particularly for a motor vehicle, having a plate in which tubes are arranged, whereby at least one turbulator is arranged in the tubes, whereby the turbulator, viewed in a longitudinal extension, has a first turbulator end and a second turbulator end, whereby a turbulator area is arranged therebetween, whereby the turbulator has a reinforced wall at least one turbulator end, whereby the reinforced wall of the turbulator, at the at least one turbulator end is thicker than the wall of the turbulator area. The invention relates further to a production method for a heat exchanger.

This nonprovisional application claims priority to German Patent Application No. DE 10 2014 200 680.5, which was filed in Germany on Jan. 16, 2014, and which is herein incorporated by reference.

### BACKGROUND OF THE INVENTION

1. Field of the Invention

The present invention relates to a heat exchanger, particularly for a motor vehicle. In addition the invention relates to a production method for a heat exchanger.

2. Description of the Background Art

A heat exchanger can be used, for example, in a climate control system of a motor vehicle. Heat exchangers can also be used as charge air coolers in the engine area of the motor vehicle, particularly for cooling the charge air of the internal combustion engine. The heat exchanger in this case has at least one plate in which tubes are arranged through which a coolant can flow. Typically, the tubes are arranged between two plates. The tubes are configured as flat tubes, for example. To optimize the coolant flow behavior, turbulators can be arranged in the tubes, particularly in flat tubes. The turbulators are corrugated fins and usually bent out of a metal sheet.

In reducing weight in the motor vehicle, it is desirable to reduce the weight of the heat exchanger as well. Two approaches are pursued in the conventional art. On the one hand, lighter materials are increasingly being employed. These are materials with a lower specific weight, for example, plastics, which are used at locations in the heat exchanger where this is possible, for example, based on the temperature. On the other hand, when metallic materials are used for the tubes, plates, and turbulators, the employed wall thicknesses are continually reduced. In this case, problems can arise in regard to the stability of the components.

Heat exchangers with a tube/plate structure are disclosed, for example, in DE 10 2011 009 825 A1 and DE 20 2011 109 859 U1, which concern a flat tube for a heat exchanger. The flat tube has two opposing tube broad side walls and an internal turbulence insert. The turbulence insert has two opposing, profiled insert broad side walls, which are supported in areas on one of the two tube broad side walls. A method for producing the flat tubes and a heat exchanger with a flat tube of this type is furthermore disclosed.

DE 20 2011 109 859 U1 discloses a flat tube with a turbulator.

### SUMMARY OF THE INVENTION

It is therefore an object of the present invention to provide an improved heat exchanger.

In an exemplary embodiment of the invention, a heat exchanger, particularly for a motor vehicle, includes a plate in which the tubes are arranged, whereby in each case at least one turbulator is arranged in the tubes, whereby the turbulator, viewed in a longitudinal extension, includes a first turbulator end and a second turbulator end with a turbulator area arranged therebetween. In this case, the turbulator has a reinforced wall at at least one turbulator end. In this case, the reinforced wall of the turbulator at the at least one turbulator end can be thicker than the wall of the turbulator area. The turbulator can be a corrugated fin that is arranged in the interior of the tube.

The turbulator can have a folded region at the at least one turbulator end. The folded region in this case can be first folded and then rolled.

In an exemplary embodiment, the turbulator can have a reinforced wall and/or a folded region at the first and second turbulator end.

In this case, a length of the reinforced wall thickness proceeding from the first and/or second turbulator end, viewed in the longitudinal direction of the turbulator, can be less than 100 mm, preferably between 5 mm and 50 mm, particularly between 10 mm and 30 mm, especially preferably about 20 mm.

The reinforced wall can have at least a double wall thickness compared with a thickness of the turbulator area.

In an embodiment of the heat exchanger, the turbulator can be a cross-folded turbulator.

The turbulator, according to an embodiment, can acquire an increased stability via the reinforced wall. In particular, a turbulator, arranged in the particular tube, can lead here to a strengthening of a tie rod function at the tube end. This can occur particularly when the tubes and the turbulator or the turbulators are fastened in the plate by a soldering process, for example. In this case, the metal sheets used for producing the turbulator can be solder plated at least in sections. The turbulator can be connected to the tube in the solder-plated sections. During the closing of the tube/plate bundles advantageously deformation of the tubes arranged in corner regions and/or of the turbulator in the corner region no longer occurs.

In this case, the greater wall thickness of the reinforced wall is realized only in the directly affected regions, particularly at the connection sites of tube/turbulator and the plate. The reinforced wall can thereby be used in a locally limited manner. Thus a great saving of weight can be achieved overall without having to accept losses in stability. This selective reinforcement of the wall at at least one turbulator end is advantageous also compared with a greater fin density, which can be used to increase stability. Overall, the local reinforcement of the wall saves material for the heat exchanger. The reinforced wall therefore also makes a contribution to cost optimization of the heat exchanger.

The object is achieved further by a production method for a heat exchanger having a plate and tubes, arranged in the plate and having at least one turbulator. The production method hereby proceeds from a metal sheet or coil, whereby at least one side edge of the metal sheet or coil is folded over in the longitudinal direction. The wall is called a folded wall when the wall sections arranged one on top of another lie substantially parallel to one another. Preferably, the folded over coil or sheet metal is then rolled by means of a turbulator roller.

The one side edge can here be a first side edge and a second side edge can also be folded over and rolled, so that a folded wall forms.

The metal sheet or coil can be folded in a cross direction in order to produce the turbulator geometry.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a section of a production method for a heat exchanger; and

FIG. 2 shows a photographic illustration of a tube/plate bundle each with a turbulator arranged in a tube according to the state of the art and according to the invention.

### DETAILED DESCRIPTION

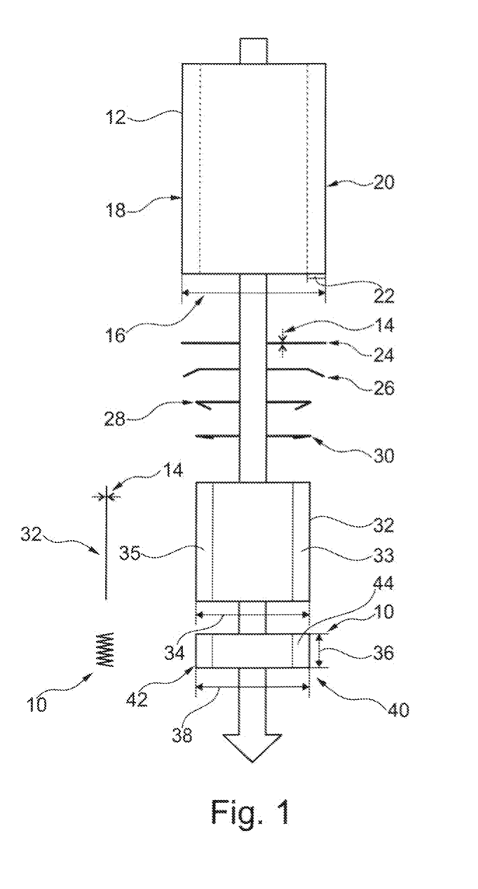

FIG. 1 shows a section of a production method for a heat exchanger that is not shown. The heat exchanger here has a tube/plate bundle. Internal corrugated fins, which are arranged in the tubes, are called turbulators 10 and can optimize the flow behavior of a fluid flowing through the tubes. In addition, external corrugated fins can also be arranged between the tubes. A tube/fin bundle can be formed hereby.

The illustrated process step shows the production of turbulator 10. Turbulator 10 is folded from a metal sheet 12, which is called a coil 12. Coil 12 can be cut from a roll or be a preformed metal sheet 12. Preferably, metal sheet 12 is a cross-rolled metal sheet 12. Metal sheet 12 has a sheet thickness 14 and a sheet width 16. In FIG. 1 thickness 14 is indicated by two arrows on a metal sheet 12, 32 showing a section of metal sheet 12 or 32. Metal sheet 12 has side edges 18 and 20.

Proceeding from side edges 18 and 20, metal sheet 12 is folded over with a fold width 22. The folding over occurs in a number of steps, of which by way of example metal sheet 12 is shown in positions 24, 26, 28, and 30. A folded metal sheet 32 with a smaller width 34 arises by the folding over. Folded metal sheet 32 hereby has width 34, which is smaller by double the fold width 22 than width 16 of metal sheet 12. In this case, fold width 22 is preferably less than 100 mm, preferably between 5 mm and 50 mm, particularly between 10 mm and 30 mm, especially preferably about 20 mm. A turbulator area 33 is formed between turbulator end 40 and turbulator end 42. Here, the twofold fold width 22 and the length of turbulator area 33 results in a turbulator length 38, which in turn corresponds to about the length of the tubes of the tube/plate bundle.

In the next process step, metal sheet 34 is folded in the longitudinal direction, so that turbulator 10 is generated. Turbulator 10 here has a width 36 and turbulator length 38. Turbulator length 38 corresponds here approximately to sheet width 34. Turbulator 10 here has a reinforced wall 44 at both turbulator ends 40 and 42. Reinforced wall 44 here comprises a folded over and rolled sheet material. Preferably, reinforced wall 44 is twice as thick as metal sheet 12. Reinforced wall 44 preferably has the double sheet thickness 14. Reinforced wall 44, however, can also have three times or four times the sheet thickness 14. In case of the threefold and/or fourfold sheet thickness 14, the folding process is designed in such a way that the threefold or fourfold wall thickness 44 is obtained.

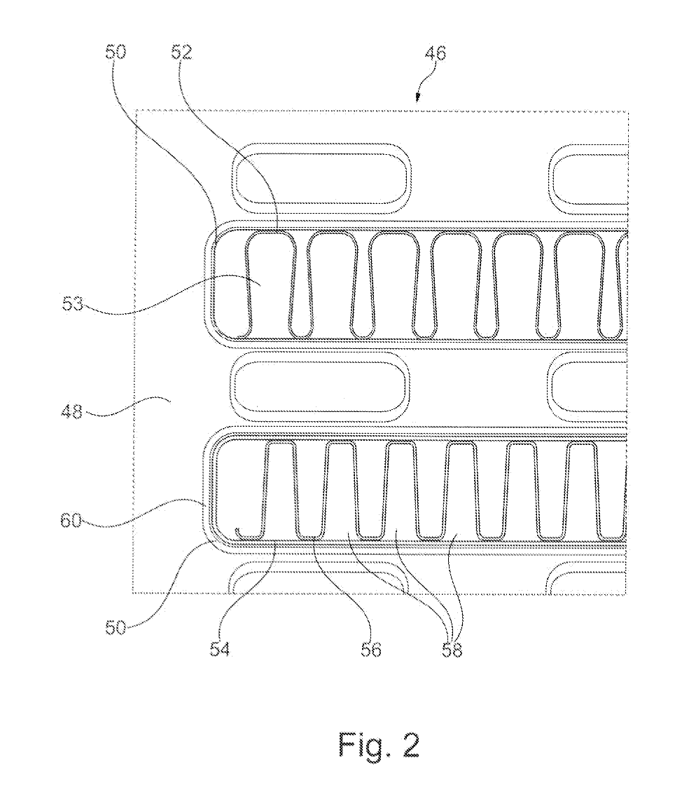

FIG. 2 shows an illustration of a section of a heat exchanger 46 with a plate 48, in which tubes 50 are arranged that are formed here as flat tubes 50. The top part of FIG. 2 shows a turbulator 52 that has a single wall thickness 53 according to the state of the art. Wall thickness 53 extends over a complete length of turbulator 52. Turbulator 52 here has an omega profile, which can cause an instability of turbulator 52 in tube 50.

In the bottom half of FIG. 2 a turbulator 56 is arranged in a tube 54. Turbulator 56 is a turbulator 10 of the invention, which at least in sections has a reinforced wall 44, particularly at turbulator ends 40 and/or 42. The same objects are designated with the same reference characters. Turbulator walls 58 have substantially a U-shape. In this case, turbulator walls 58 run substantially perpendicular to a tube wall 60 of tubes 54. The stability of turbulator 56 is produced by reinforced wall 44, which has at least a double wall thickness compared with sheet thickness 14. Reinforced wall 44, however, can also be thicker than the double sheet thickness 14. Reinforced wall 44 can preferably be three times or four times or in general many times as thick compared with sheet thickness 14. Turbulator area 33 is formed between turbulator ends 40 and 42. Turbulator area 33 here has wall thickness 14 of metal sheet 12.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A heat exchanger for a motor vehicle, the heat exchanger comprising:
a plurality of tubes;
a plate in which the tubes are arranged;
at least one turbulator arranged in the tubes, the turbulator, viewed in a longitudinal extension, has a first turbulator end and a second turbulator end;
a turbulator area arranged between the first and second turbulator end; and
a reinforced wall provided at the first or second turbulator end, the reinforced wall of the turbulator being thicker than a wall of the turbulator area.

2. The heat exchanger according to claim 1, wherein the turbulator has a folded region at the first or second turbulator end.

3. The heat exchanger according to claim 1, wherein the turbulator has a reinforced wall and/or a folded region at the first and/or second turbulator end.

4. The heat exchanger according to claim 1, wherein, viewed in the longitudinal direction of the turbulator, a length of the reinforced wall proceeding from the first and/or second turbulator end is less than 100 mm, between 5 mm and 50 mm, between 10 mm and 30 mm, or about 20 mm.

5. The heat exchanger according to claim 1, wherein the reinforced wall comprises at least a double wall thickness compared with a sheet thickness.

6. The heat exchanger according to claim 1, wherein the turbulator is a cross-folded turbulator.

7. A production method for a heat exchanger having a plate and tubes arranged in the plate and having at least one turbulator, the method comprising:
cutting a metal sheet; and
folding over at least one side edge of the metal sheet in a longitudinal direction.

8. The production method according to claim 7, wherein the folded over sheet is rolled via a turbulator roller in a region of the folded sheet.

9. The production method according to claim 7, wherein one side edge is a first side edge and a second side edge is folded over and rolled.

10. The production method according to claim 7, wherein the metal sheet is folded in a cross direction in order to produce the turbulator geometry.
